(19) United States
(12) Patent Application Publication
(10) Pub. No.: US 2021/0039353 A1
(43) Pub. Date: Feb. 11, 2021

(54) CUSHIONING SEAL MEMBER AND DISPLAY APPARATUS

(71) Applicant: Mitsubishi Electric Corporation, Tokyo (JP)

(72) Inventor: Yasuhiro ARAKI, Tokyo (JP)

(73) Assignee: Mitsubishi Electric Corporation, Tokyo (JP)

(21) Appl. No.: 16/912,502

(22) Filed: Jun. 25, 2020

(30) Foreign Application Priority Data
Aug. 6, 2019 (JP) 2019-144691

(51) Int. Cl. B32B 7/12; B32B 17/06; G02F 1/1333

(52) U.S. Cl. CPC B32B 7/12; B32B 17/064; B32B 2307/42; B32B 2457/208; B32B 2457/202; G02F 1/133308

(57) ABSTRACT

The seal material has an end portion intersecting the longitudinal direction of the seal material. The peeling film and the structural portion are configured such that the region where the structural portion exists out of the seal material is a starting point where the peeling film is peeled from the seal material in a plan view.

### BACKGROUND OF THE INVENTION

### Field of the Invention

The present invention relates to a cushioning seal member and a display apparatus used for fixing a target object.

### Description of the Background Art

The display apparatus generally includes a support member that supports the display panel. In such a display apparatus, a seal material is provided on a part of the support member on which the display panel is to be installed. Thus, the display panel can be easily fixed to the support member.

At this time, if stress is applied to the display panel, unevenness occurs on the display surface of the display panel and the display quality is degraded. Therefore, the display apparatus has a structure of fixing the display panel to the support member using a cushioning seal member. The cushioning seal member includes a cushion material having high elasticity and a seal material.

When the display panel is fixed to the support member, first, the peeling film stuck to the seal material of the cushioning seal member arranged in the planar light source apparatus is peeled. The seal material is a seal material existing on the display panel side in the cushioning seal member. Then, the seal material is stuck to the display panel.

Generally, when the peeling film is peeled, a load is applied to the cushion material, and defects such as tearing occur in the cushion material. Therefore, a structure of suppressing the application of a load to the cushion material is required.

Japanese Patent Application Laid-Open No. 2017-214468 discloses a cushioning seal member having a configuration (hereinafter, also referred to as a “related configuration A”) that suppresses the occurrence of defects in the cushion material. In the related configuration A, the adhesive member (seal material) used for fixing to the display panel is laminated on a portion, other than one end portion, of one surface of the cushion material. Thus, it is possible to suppress the application of a load to the cushion material when the peeling film is peeled.

In the related configuration A, the starting point where the peeling film (peeling member) is peeled from the seal material is an end portion of the seal material in the longitudinal direction of the seal material. It should be noted that the peeling force of the peeling film increases as the peeling speed increases. Therefore, when the peeling force of the peeling film is large when the peeling film is peeled, the peeling force is transmitted to the end portion of the cushion material through the end portion of the seal material, and tearing may occur at the end portion of the cushion material.

Thus, it is required that the starting point where the peeling film is peeled from the seal material does not exist at the end portion of the seal material.

### SUMMARY

An object of the present invention is to provide a cushioning seal member or the like in which the starting point where the peeling film is peeled from the seal material does not exist at the end portion of the seal material.

A cushioning seal member according to an aspect of the present invention includes: a cushion material having a front surface; and a seal material provided on the front surface. A peeling film is provided on the seal material. The seal material has a long shape. The peeling film is configured to be peelable from the seal material. The seal material has an end portion intersecting a longitudinal direction of the seal material. A structural portion exists at a portion different from the end portion out of the seal material. The peeling film and the structural portion are configured such that a region where the structural portion exists out of the seal material is a starting point where the peeling film is peeled from the seal material in a plan view.

According to the present invention, the seal material has an end portion intersecting the longitudinal direction of the seal material. The peeling film and the structural portion are configured such that the region where the structural portion exists out of the seal material is a starting point where the peeling film is peeled from the seal material in a plan view.

That is, in a plan view, the region in which the structural portion exists is the starting point where the peeling film is peeled from the seal material. It should be noted that the structural portion exists in a portion different from the end portion out of the seal material.

Thus, it is possible to provide a cushioning seal member in which the starting point where the peeling film is peeled from the seal material does not exist at the end portion of the seal material.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view of a display apparatus according to a first preferred embodiment;

FIG. 2 is a plan view of the display apparatus according to the first preferred embodiment;

FIG. 3 is a cross-sectional view of the display apparatus taken along line A1-A2 in FIG. 2;

FIG. 4 is an external view of a display panel according to the first preferred embodiment;

FIG. 5 is a side view of a cushioning seal member according to the first preferred embodiment;

FIG. 6 is a top view of the configuration in FIG. 5;

FIG. 7 is a plan view showing a configuration of a seal material;

FIG. 8 is a diagram for illustrating a fixing process;

FIG. 9 is a plan view of a peeling film having a modified configuration A;

FIG. 10 is a plan view of a peeling film having a modified configuration B;

FIG. 11 is a diagram showing a state in which a plurality of peeling films and cushioning seal members having a modified configuration B are arranged;

FIG. 12 is a side view of a cushioning seal member having the configuration of a first modification; and

FIG. 13 is a side view of a cushioning seal member having the configuration of a second modification.

### DESCRIPTION OF THE PREFERRED EMBODIMENTS

Hereinafter, a preferred embodiment will be described with reference to the drawings. In the following drawings, the same components are denoted by the same reference numerals. It should be noted that the component denoted by the same reference numeral has the same or substantially the same function.

It should be noted that the dimensions, materials, and shapes of components exemplified in the preferred embodiment, relative arrangements of the components, and the like may be appropriately changed according to the configuration, various conditions, and the like of the apparatus. In addition, the dimensions of components in the drawing may differ from the actual dimensions.

### First Preferred Embodiment

### Overall Configuration of Display Apparatus

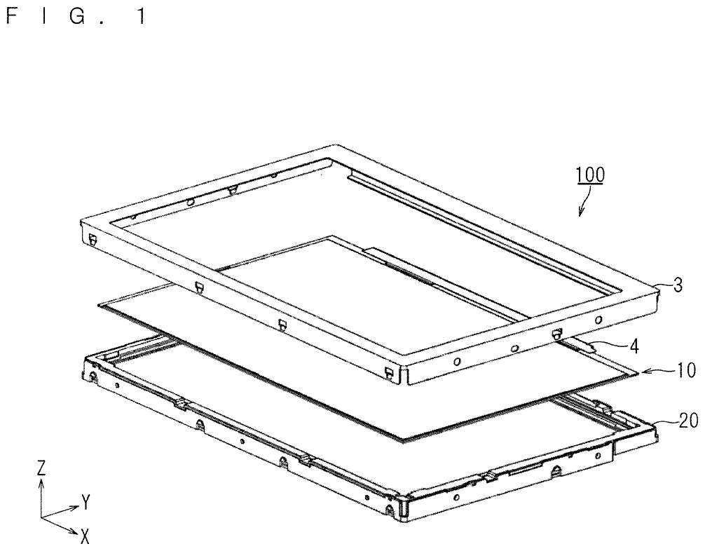

FIG. 1 is an exploded perspective view of a display apparatus 100 according to the first preferred embodiment. The display apparatus 100 is, for example, a liquid crystal display apparatus for displaying a video using liquid crystal.

In FIG. 1, the X direction, the Y direction, and the Z direction are orthogonal to one another. The X, Y, and Z directions illustrated in the following drawings are also orthogonal to one another. Hereinafter, a direction including the X direction and a direction opposite to the X direction (−X direction) is also referred to as an “X-axis direction”. In addition, hereinafter, a direction including the Y direction and a direction opposite to the Y direction (−Y direction) is also referred to as a “Y-axis direction”. In addition, hereinafter, a direction including the Z direction and a direction opposite to the Z direction (−Z direction) is also referred to as a “Z-axis direction”.

In addition, hereinafter, a plane including the X-axis direction and the Y-axis direction is also referred to as an “XY plane”. In addition, hereinafter, a plane including the X-axis direction and the Z-axis direction is also referred to as an “XZ plane”. In addition, hereinafter, a plane including the Y-axis direction and the Z-axis direction is also referred to as a “YZ plane”.

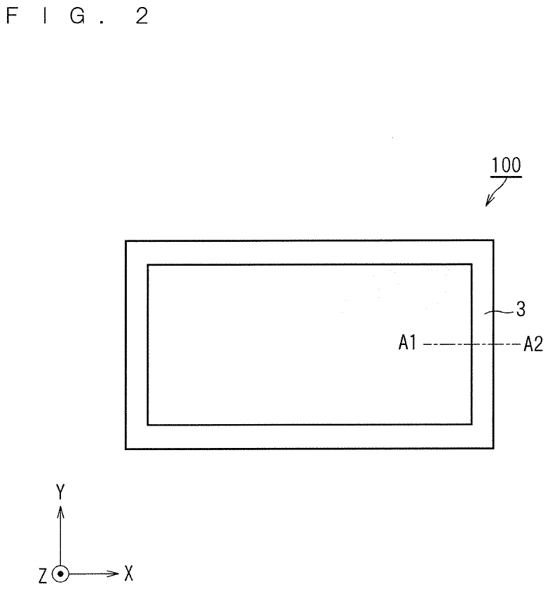

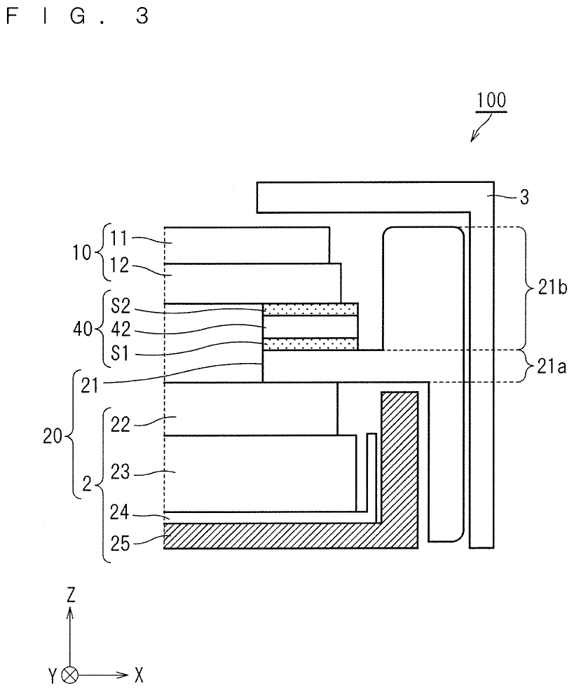

FIG. 2 is a plan view of the display apparatus 100 according to the first preferred embodiment. FIG. 3 is a cross-sectional view of the display apparatus 100 taken along line A1-A2 in FIG. 2. Referring to FIGS. 1, 2, and 3, the display apparatus 100 includes a front frame 3, a display panel 10, a circuit board 4, and a support member 20. The front frame 3 has an opening. The front frame 3 covers the rim portion of the display panel 10 and the rim portion of the support member 20.

The display panel 10 displays an image (video). The display panel 10 is, for example, a liquid crystal display panel. The support member 20 supports the display panel 10.

In addition, a touch panel (not shown) and a protective member (not shown) may be provided in front of the display panel 10. The touch panel includes a screen. The touch panel accepts touch operation on the screen. In this case, the touch panel transmits a position signal indicating the touch position on the screen to, for example, a control unit (not shown). The protective member is a member that protects the touch panel. The protective member is made of a transparent material having translucency.

In addition, a cover (not shown) may be provided behind the display panel 10. The cover protects the circuit board of the display panel 10.

Next, each of the members constituting the display apparatus 100 will be described in more detail.

### Display Panel

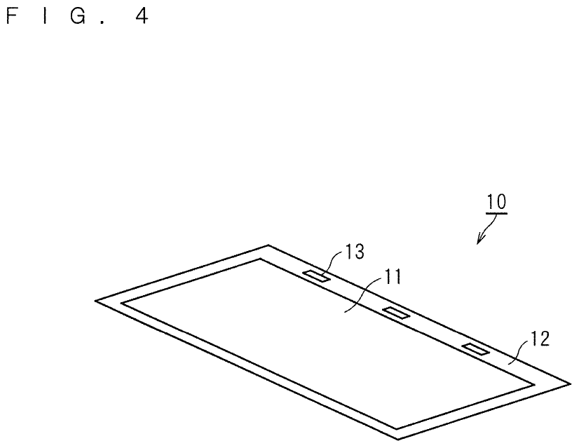

FIG. 4 is an external view of the display panel 10 according to the first preferred embodiment. The display panel 10 is a liquid crystal display panel as described above. The liquid crystal display panel is a panel to which birefringence of the liquid crystal material is applied.

Referring to FIGS. 3 and 4, the display panel 10 includes a substrate 11 and a substrate 12. The substrate 11 is an insulating substrate such as glass. A color filter (CF), a light shielding layer, a counter electrode, and the like are formed on the substrate 11.

The substrate 12 is an insulating substrate such as glass. Switching elements, pixel electrodes, and the like are formed on the substrate 12. The switching element is a thin film transistor (TFT).

The display panel 10 further includes a spacer (not shown), a seal material (not shown), a liquid crystal layer (not shown), a sealing material (not shown), and an alignment film (not shown), a polarizing plate (not shown), and a driving IC 13.

The substrate 11 and the substrate 12 are provided to face each other. The spacer is provided to create a predetermined space between the substrate 11 and the substrate 12. The seal material is a member for bonding the substrate 11 and the substrate 12 to each other. The liquid crystal layer is sandwiched between the substrate 11 and the substrate 12.

The sealing material is a member that seals an injection port for injecting liquid crystal. The alignment film is a film for aligning liquid crystal constituting the liquid crystal layer. The polarizing plate is provided on the outer side surface of the substrate 11. In addition, the polarizing plate is also provided on the outer side surface of the substrate 12.

The driving IC 13 is provided on the rim portion of the substrate 12. It should be noted that the driving IC 13 may be provided on a tape-shaped wiring material (TCP, COF, and the like) connected to the rim portion of the substrate 12.

### Support Member

Referring to FIG. 3, the support member 20 supports the display panel 10. The support member 20 includes a front casing 21 and a planar light source apparatus 2. The front casing 21 is a frame. The frame is made of metal. The metal is, for example, aluminum, stainless steel, iron, or the like.

It should be noted that the frame may be made of a resin material. The resin material is polycarbonate (PC), acrylonitrile butadiene styrene (ABS), or the like.

The planar light source apparatus 2 emits light toward the back surface (substrate 12 side) of the display panel 10. The planar light source apparatus 2 includes a light source (not shown), an optical sheet 22, a light guide plate 23, a reflection sheet 24, and a back casing 25.

The light source emits light. The light guide plate 23 guides the light emitted by the light source in a specific direction. The light guide plate 23 is a member for guiding light to the optical sheet 22. The light guide plate 23 has a side surface, an emitting surface, and an anti-emitting surface. The emitting surface is a surface from which light is emitted. The anti-emitting surface is a surface opposite to the emitting surface out of the light guide plate 23. The light emitted by the light source enters the light guide plate 23 from the side surface of the light guide plate 23. Most of the light incident on the light guide plate 23 is emitted in the Z direction from the emitting surface of the light guide plate 23.

The optical sheet 22 is provided on the emitting surface of the light guide plate 23. The optical sheet 22 controls the distribution and spread of the light emitted from the light guide plate 23. The reflection sheet 24 is a sheet that reflects light. The light emitted from the anti-emitting surface of the light guide plate 23 is reflected by the reflection sheet 24, and enters the light guide plate 23 again. The back casing 25 holds the optical sheet 22, the light guide plate 23, and the reflection sheet 24.

### Light Source

The light source is a point-shaped light source, an LED, a fluorescent tube lamp, or the like. The point-shaped light source emits RGB (three primary colors) light. The RGB light includes red light, green light, and blue light. When the point-shaped light source is used, a light source substrate on which the point-shaped light source is mounted is used. The light source substrate is made of a general glass epoxy resin as a base.

It should be noted that in order to increase the heat dissipation of the light source substrate, the light source substrate may be made of a metal such as aluminum or a ceramic as a base. In addition, when a point-shaped light source is used, a flexible flat cable may be used. The LED emits light different from RGB light (for example, white light).

### Light Guide Plate

The light guide plate 23 is made of a transparent material. The transparent material is acrylic resin, polycarbonate resin, glass, or the like. A light scattering portion is formed on one or both of the emitting surface and the anti-emitting surface of the light guide plate 23. The light scattering portion has a structure for emitting light from the emitting surface and adjusting the intensity distribution of light in the surface, the emission direction of light, and the like. The light scattering portion is, for example, a scattering dot pattern. In addition, the light scattering portion has, for example, a prism shape.

### Optical Sheet

The optical sheet 22 is provided on the emitting surface of the light guide plate 23 as described above. The optical sheet 22 is a member for adjusting the intensity distribution of emission light, the emission angle of light, and the like.

The optical sheet 22 is configured using a required number of lens sheets, diffuser sheets, viewing angle adjustment sheets, and the like according to the purpose. The lens sheet is used for collecting light. The diffuser sheet is used for uniformizing the light. The viewing angle adjustment sheet is used for adjusting the brightness of light in the viewing angle direction.

### Front Casing

The front casing 21 has an opening for the light emitted by the planar light source apparatus 2 to pass through. The shape of the front casing 21 in a plan view (XY plane) is a closed loop shape. In addition, as shown in FIG. 3, the front casing 21 has a plate-shaped portion 21a and a protruding portion 21b.

The front casing 21 is made of metal. The metal is, for example, aluminum, stainless steel, iron, or the like. It should be noted that the front casing 21 may be made of a resin material. The resin material is PC, ABS, or the like.

### Back Casing

The back casing 25 positions and holds a light source (not shown) and a light source substrate (not shown). In order to conduct the heat emitted from the light source, the back casing 25 is made of metal having high thermal conductivity. The metal having high thermal conductivity is, for example, aluminum, an aluminum alloy, or the like. The back casing 25 made of metal having high thermal conductivity efficiently dissipates heat from the light source of the light source substrate. Thus, it is possible to prevent heat from being trapped in the planar light source apparatus 2.

The front casing 21 and the back casing 25 are generally fixed to each other with a hooking structure using a claw, a screw clamp, or the like. Thus, another planar light source apparatus member, the display panel 10, the circuit board 4, and the like are held. It should be noted that the front casing 21 and the back casing 25 may be integrated.

### Circuit Board

The circuit board 4 controls the display panel 10, the light source, and the like with electrical input/output signals. The circuit board 4 is manufactured as follows. For example, a copper pattern is formed on a glass epoxy or the like. Then, electronic components are mounted on the front surface of the glass epoxy or the like by soldering. The circuit board 4 is mainly arranged on the back surface side (side from which light is not emitted) of the display apparatus 100 and fixed thereto.

It should be noted that the circuit board 4 may be configured by mounting electronic components on the FPC. The FPC is obtained by forming wiring on a base material on a film connected to the display panel 10.

In addition, in order to protect the circuit board 4 from external pressure, static electricity, and the like, a protective cover (not shown) may be attached to the circuit board 4. The protective cover is made of, for example, metal or film-shaped thin resin. The metal is aluminum, stainless steel, galvanized steel sheet, or the like. In addition, the resin is polyethylene terephthalate (PET) or the like.

It should be noted that when a metal protective cover is used, it is necessary to avoid electrical contact with the circuit board 4 and electronic components on the circuit board 4. Thus, it is desirable to stick a resin sheet such as PET to the circuit board 4 side to take insulation measures.

### Characteristic Configuration

Next, a characteristic configuration of the present preferred embodiment will be described. The display apparatus 100 further includes a cushioning seal member 40. The cushioning seal member 40 is used for fixing the display panel 10 to the support member 20.

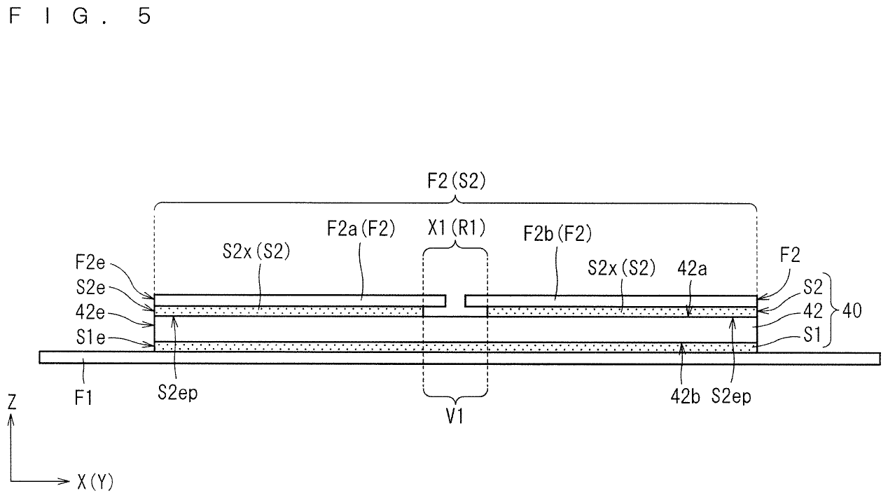

FIG. 5 is a side view of the cushioning seal member 40 according to the first preferred embodiment. It should be noted that FIG. 5 shows a state in which peeling films F1 and F2 are provided on the cushioning seal member 40.

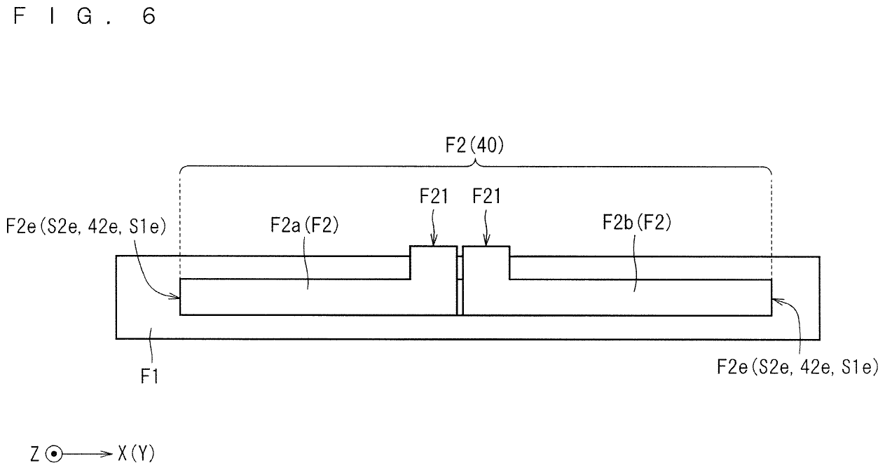

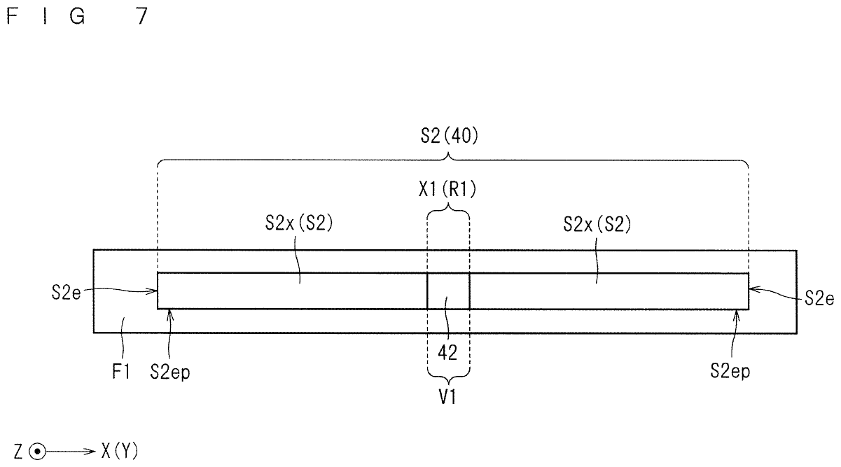

FIG. 6 is a top view of the configuration in FIG. 5. The cushioning seal member 40 has a long shape. FIG. 7 is a plan view showing a configuration of a seal material S2 described below. It should be noted that FIG. 7 is a plan view showing a state in which the peeling film F2 is omitted from the configuration in FIG. 6.

Referring to FIGS. 5, 6, and 7, the cushioning seal member 40 includes seal materials S1 and S2 and a cushion material 42. The cushion material 42 has a front surface 42a and a back surface 42b. Each of the seal materials S1 and S2 has adhesiveness. Each of the seal materials S1 and S2 has a sheet shape.

The seal material S2 is provided on the front surface 42a of the cushion material 42. The seal material S1 is provided on the back surface 42b of the cushion material 42. It should be noted that a peeling film F2 is provided on the seal material S2. The peeling film F2 is a film configured to be peelable from the seal material S2. Each of the peeling film F2, the seal material S2, the cushion material 42, and the seal material S1 has a long shape.

Hereinafter, the state in which the peeling film F2 is peeled from the seal material S2 of the cushioning seal member 40 is also referred to as a “peeled state”. In addition, hereinafter, the state in which the peeling film F2 is provided on the seal material S2 of the cushioning seal member 40 is also referred to as a “non-peeled state”.

In the non-peeled state, the seal material S1, the cushion material 42, the seal material S2, and the peeling film F2 are laminated in the order of the seal material S1, the cushion material 42, the seal material S2, and the peeling film F2.

As shown in FIGS. 5 and 7, the seal material S2 has two end portions S2ep. Each end portion S2ep intersects the longitudinal direction of the seal material S2.

In addition, referring to FIGS. 5 and 6, the seal material S1 has two ends S1e. Each end S1e intersects the longitudinal direction of the seal material S1. The cushion material 42 has two ends 42e. Each end 42e intersects the longitudinal direction of the cushion material 42. The seal material S2 has two ends S2e. The two ends S2e are respective tips of the two end portions S2ep. Each end S2e intersects the longitudinal direction of the seal material S2. The peeling film F2 has two ends F2e. Each end F2e intersects the longitudinal direction of the peeling film F2.

In the non-peeled state, the positions of the end F2e, the end S2e, the end 42e, and the end S1e are aligned in the longitudinal direction of the seal material S2. (See FIGS. 5 and 6). In other words, in the non-peeled state, the end F2e, the end S2e, the end 42e, and the end S1e exist at the same position in a plan view. It should be noted that the expression “same position” also includes the meaning of “equivalent position”.

The peeling film F1 is provided on the lower surface of the seal material S1 of the cushioning seal member 40. The peeling film F1 is a film configured to be peelable from the seal material S1 (cushioning seal member 40). Hereinafter, the state in which the peeling film F1 is peeled from the seal material S1 (cushioning seal member 40) is also referred to as a “film peeled state”. In addition, hereinafter, the state in which the peeling film F1 is provided on the lower surface of the seal material S1 of the cushioning seal member 40 is also referred to as a “film non-peeled state”.

In addition, hereinafter, a portion different from the end portion S2ep out of the seal material S2 is also referred to as a “non-end portion”. As shown in FIGS. 5 and 7, a structural portion X1 exists at a non-end portion of the seal material S2. Hereinafter, in a plan view, the region in which the structural portion X1 exists out of the seal material S2 is also referred to as a “region R1”.

The peeling film F2 and the structural portion X1 are configured such that the region R1 of the seal material S2 is a starting point where the peeling film F2 is peeled from the seal material S2 in a plan view. Specifically, the peeling film F2 is divided in the region R1 where the structural portion X1 exists in a plan view (see FIGS. 5 and 6).

The structural portion X1 existing in the seal material S2 is a seal material removed portion V1 (see FIGS. 5 and 7). The seal material removed portion V1 is a portion, out of the seal material S2, from which the member constituting the seal material S2 is removed. The seal material removed portion V1 is, for example, a space.

The seal material S2 includes two seal materials S2x. Each seal material S2x is a part of the seal material S2. As shown in FIGS. 5 and 7, the two seal materials S2x are arranged at an interval in the longitudinal direction of the seal material S2. The seal material removed portion V1 is a space existing between the two seal materials S2x. Thus, as shown in FIG. 7, a part of the cushion material 42 is exposed between the two seal materials S2x.

It should be noted that the seal material removed portion V1 is not limited to the space. The seal material removed portion V1 may be a recess, for example.

In addition, as shown in FIGS. 5 and 6, the peeling film F2 is divided on the structural portion X1 (seal material removed portion V1). Therefore, the peeling film F2 includes the peeling films F2a and F2b. Each of the peeling films F2a and F2b has an end F2e.

Hereinafter, the place where the peeling film F2 is divided is also referred to as a “divided place”. In addition, hereinafter, the work for an operator to peel the peeling film F2 from the cushioning seal member 40 (seal material S2) in the non-peeled state is also referred to as “peeling work”. The peeling work is also a work for peeling one or both of the peeling films F2a and F2b from the cushioning seal member 40.

The peeling films F2a and F2b have respective two handle portions F21 (see FIG. 6). In the non-peeled state, each handle portion F21 is not in contact with the seal material S2. Each handle portion F21 is a portion grasped by the operator when the peeling work is performed. The shape of the handle portion F21 is, for example, a rectangle.

The two handle portions F21 exist at the divided place (region R1) of the peeling film F2 or at a portion near the divided place (region R1) out of the peeling film F2. The two handle portions F21 protrude from the peeling film F2 toward the same direction, for example.

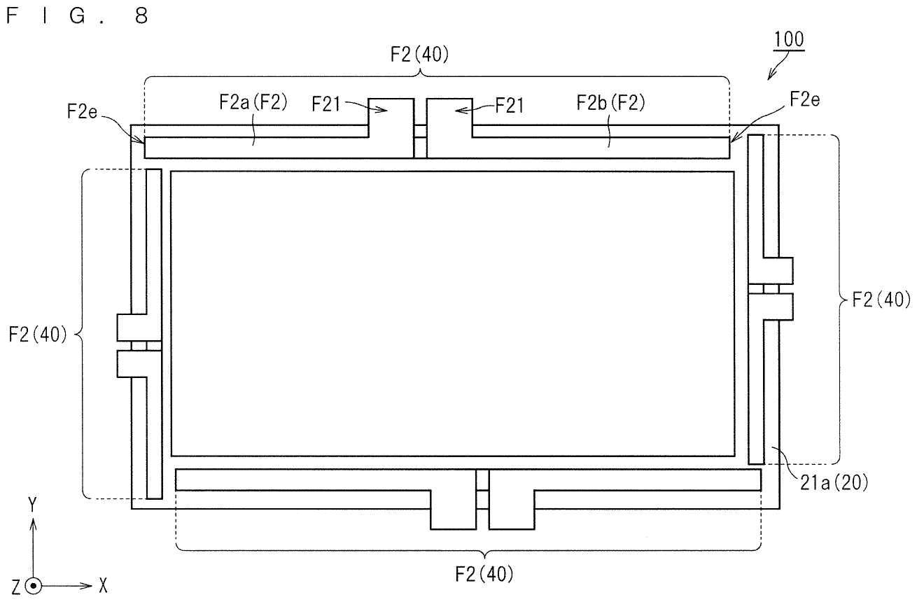

Next, a process for fixing the display panel 10 to the support member 20 (hereinafter, also referred to as “fixing process”) will be described. FIG. 8 is a diagram for illustrating the fixing process. In addition, FIG. 8 is a plan view of the display apparatus 100 according to the first preferred embodiment. It should be noted that FIG. 8 does not show the front frame 3, the display panel 10, and the protruding portion 21b of the front casing 21 in order to make the fixing process easy to understand. In addition, FIG. 8 shows a state in which the four cushioning seal members 40 in the non-peeled state are stuck to the plate-shaped portion 21a of the front casing 21 in the support member 20. It should be noted that the plate-shaped portion 21a has a closed loop shape in a plan view.

In the fixing process, first, the four cushioning seal members 40 in the non-peeled state are stuck to the plate-shaped portion 21a of the front casing 21 as shown in FIG. 8.

Next, the above-described peeling work is performed on each of the four cushioning seal members 40 in the non-peeled state. Here, as an example, a peeling work performed on the cushioning seal member 40 extending in the X-axis direction in FIG. 8 will be described.

Referring to FIGS. 8 and 6, in the peeling work, the peeling film F2a (peeling film F2) is peeled from the seal material S2 so that, for example, the handle portion F21 of the peeling film F2a is moved to the end F2e of the peeling film F2a. In addition, in the peeling work, the peeling film F2b (peeling film F2) is peeled from the seal material S2 so that, for example, the handle portion F21 of the peeling film F2b is moved to the end F2e of the peeling film F2b. That is, the divided place of the peeling film F2 is the starting point where the peeling film F2 is peeled from the seal material S2.

The work similar to the above-described peeling work is performed also on the other cushioning seal members 40. Thus, the peeling film F2 of each of the four cushioning seal members 40 in the non-peeled state is peeled.

Thereafter, the display panel 10 is stuck to the seal material S2 of each cushioning seal member 40. Thus, as shown in FIG. 3, the display panel 10 is fixed to the support member 20 with the cushioning seal member 40 therebetween. Hereinafter, the state in which the display panel 10 is fixed to the support member 20 with the cushioning seal member 40 therebetween is also referred to as a “fixed state”. In the fixed state, the cushioning seal member 40 is sandwiched between the display panel 10 and the support member 20.

### Summary

As described above, according to the present preferred embodiment, the seal material S2 has the end portion S2ep intersecting the longitudinal direction of the seal material S2. The peeling film F2 and the structural portion X1 are configured such that the region R1 where the structural portion X1 exists out of the seal material S2 is a starting point where the peeling film F2 is peeled from the seal material S2 in a plan view.

That is, in a plan view, the region R1 in which the structural portion X1 exists is the starting point where the peeling film F2 is peeled from the seal material S2. It should be noted that the structural portion X1 exists at a portion different from the end portion S2ep out of the seal material S2.

Thus, it is possible to provide a cushioning seal member in which the starting point where the peeling film is peeled from the seal material does not exist at the end portion of the seal material.

In addition, according to the present preferred embodiment, the structural portion X1 (seal material removed portion V1) exists at a portion different from the end portion S2ep out of the seal material S2. The peeling film F2 is divided in a region R1 where the structural portion X1 exists in a plan view. Therefore, the divided place (region R1) of the peeling film F2 is the starting point where the peeling film F2 is peeled from the seal material S2.

As described above, in the peeling work, the peeling film F2a is peeled from the seal material S2 so that the handle portion F21 of the peeling film F2a (peeling film F2) existing in the divided place is moved to the end F2e of the peeling film F2a. Thus, it is possible to suppress the application of a very large peeling force to the cushion material 42 when the peeling work is performed.

Therefore, the stress occurring in the cushion material 42 can be relaxed. Therefore, it is possible to suppress the occurrence of defects in the cushion material 42 of the cushioning seal member 40. The defect is, for example, a defect that the cushion material 42 is torn. In other words, the peeling force occurring when the peeling work is performed makes it possible to suppress the occurrence of the above-described defects in the cushion material 42 of the cushioning seal member 40.

In addition, in the present preferred embodiment, the divided place of the peeling film F2 is arranged on the structural portion X1 being the seal material removed portion V1. Therefore, the portion existing on the seal material removed portion V1 (structural portion X1) out of the peeling film F2 is not previously bonded to the seal material S2. Therefore, the peeling work can be easily performed.

It should be noted that in the related configuration A described above, the adhesive member (seal material) is laminated on a portion, other than one end portion, of one surface of the cushion material. It should be noted that the peeling force of the peeling film (peeling member) increases as the peeling speed increases. It should be noted that when the peeling film is peeled, the peeling force is transmitted from the end portion of the seal material (adhesive member) to the cushion material.

Therefore, in the related configuration A, when the peeling film is peeled, if such a large stress as cannot be relaxed by the cushion material occurs in the cushion material, there is a problem that tearing occurs at the end portion of the cushion material.

Thus, the cushioning seal member 40 of the present preferred embodiment has a configuration for producing the above effects. Therefore, the cushioning seal member 40 of the present preferred embodiment can solve the above problems.

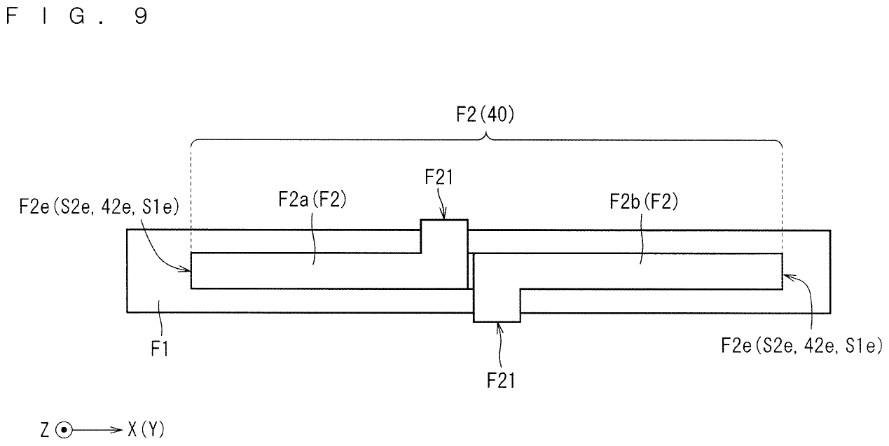

It should be noted that the configuration of the peeling film F2 is not limited to the configuration shown in FIG. 6. For example, the peeling film F2 may have the configuration shown in FIG. 9 (hereinafter, also referred to as a “modified configuration A”).

In the peeling film F2 in the modified configuration A, the two handle portions F21 protrude toward different directions from the peeling film F2. That is, the direction in which the one handle portion F21 protrudes is a direction opposite to the direction in which the other handle portion F21 protrudes.

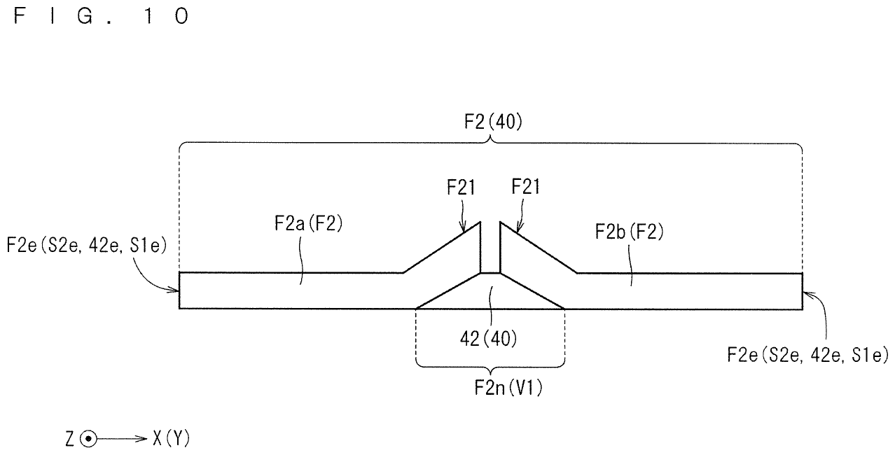

In addition, the peeling film F2 may have the configuration shown in FIG. 10 (hereinafter, also referred to as a “modified configuration B”). In the peeling film F2 in the modified configuration B, each of the two handle portions F21 has a substantially triangular shape. Therefore, the peeling film removed portion F2n also has a substantially triangular shape. The peeling film removed portion F2n is a region where the material constituting the peeling film is removed from the peeling film F2.

It should be noted that FIG. 10 shows, as an example, a state in which the shape of the seal material removed portion V1 in a plan view is the same as the shape of the peeling film removed portion F2n in a plan view. Therefore, a part of the cushion material 42 is exposed in the peeling film removed portion F2n.

It should be noted that the peeling film F2 having the modified configuration B is provided on the seal material S2 (cushioning seal member 40).

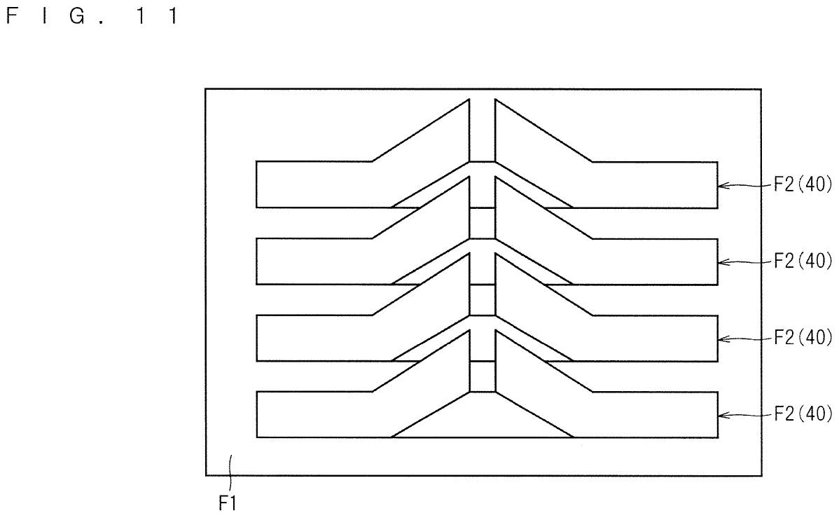

In addition, a plurality of peeling films F2 and cushioning seal members 40 having a plurality of modified configuration B, each of which is shown in FIG. 10, may be arranged on the peeling film F1 (see FIG. 11). Thus, it is possible to increase the number of products that can be taken during production.

### First Modification

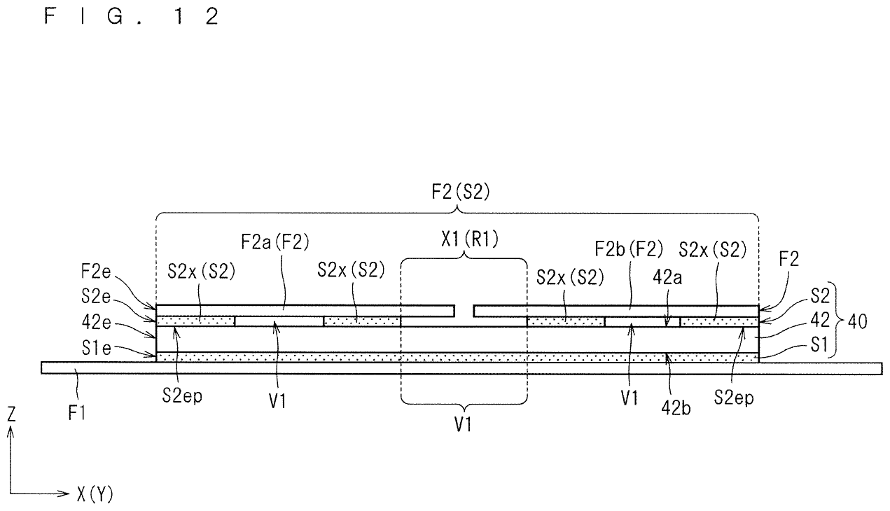

The configuration of the present modification is applied to the first preferred embodiment. FIG. 12 is a side view of a cushioning seal member 40 having the configuration of the first modification. In the first preferred embodiment, one seal material removed portion V1 is provided at a non-end portion of the seal material S2.

In the present modification, as shown in FIG. 12, a plurality of seal material removed portions V1 exist at non-end portions of the seal material S2. Each of the seal material removed portions V1 is a portion, out of the seal material S2, from which the member constituting the seal material S2 is removed. Each of the seal material removed portions V1 is, for example, a space.

The seal material S2 includes a plurality of seal materials S2x. Each seal material S2x is a part of the seal material S2. As shown in FIG. 12, a plurality of seal materials S2x are arranged at intervals in the longitudinal direction of the seal material S2. The seal material removed portion V1 is a space existing between the two adjacent seal materials S2x.

It should be noted that the seal material removed portion V1 is not limited to the space. The seal material removed portion V1 may be a recess, for example.

In addition, a structural portion X1 exists at a non-end portion of the seal material S2. In the present modification, the structural portion X1 is one seal material removed portion V1 included in a plurality of seal material removed portions V1. In addition, the peeling film F2 is divided in a region R1 where the structural portion X1 exists in a plan view.

It should be noted that in the present modification, performing the above- described fixing process fixes the display panel 10 to the support member 20 with the cushioning seal member 40 therebetween as shown in FIG. 3.

As described above, according to the present modification, the plurality of seal material removed portions V1 exist at non-end portions of the seal material S2. The existence of the plurality of seal material removed portions V1 reduces the adhesive area between the display panel 10 and the cushioning seal member 40 in a fixed state where the cushioning seal member 40 is sandwiched between the display panel 10 and the support member 20.

Therefore, the stress of the display panel 10 in the fixed state where the cushioning seal member 40 is sandwiched by the display panel 10 and the support member 20 can be relaxed (reduced). The stress of the display panel 10 is the force occurring in the display panel 10 caused by the cushioning seal member 40 pulling the display panel 10 due to the difference in linear expansion coefficient between the display panel 10 and the support member 20 at the time of heat shrinkage.

### Second Modification

The present modification is applied to the first preferred embodiment. The configuration of the present modification is similar to the configuration of the first modification. The configuration of the present modification is different from the configuration of the first modification in that the structural portion X1 is a part of the seal material S2. The configuration of the present modification other than that is similar to the configuration of the first modification.

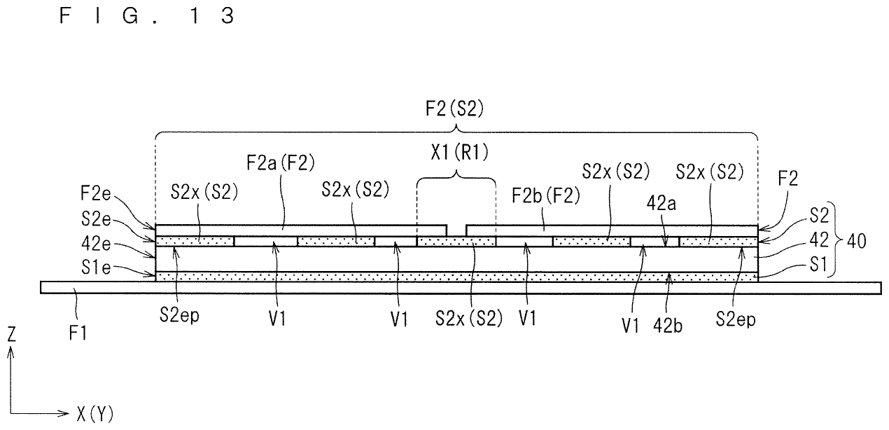

FIG. 13 is a side view of a cushioning seal member 40 having the configuration of the second modification. In the present modification, a plurality of seal material removed portions V1 exist at non-end portions of the seal material S2. In addition, the peeling film F2 is divided in a region R1 where the seal material S2 exists in a plan view.

In addition, in the present modification, a structural portion X1 exists at a non-end portion of the seal material S2. The structural portion X1 of the present modification is one seal material S2x included in a plurality of seal materials S2x constituting the seal material S2. That is, in the present modification, the structural portion X1 existing in the seal material S2 is a part of the seal material S2.

As described above, according to the present modification, the peeling film F2 is divided in the region R1 where the seal material S2 exists in a plan view. Also in this configuration, the effects of the first preferred embodiment and the first modification can be obtained.

It should be noted that in the present invention, the preferred embodiment and each of the modifications can be freely combined, and the preferred embodiment and each of the modifications can be appropriately modified or omitted within the scope of the present invention.

While the invention has been shown and described in detail, the foregoing description is in all aspects illustrative and not restrictive. It is therefore understood that numerous modifications and variations can be devised without departing from the scope of the invention.

What is claimed is:

1. A cushioning seal member comprising:
a cushion material having a front surface; and
a seal material provided on the front surface,
wherein a peeling film is provided on the seal material,
wherein the seal material has a long shape,
wherein the peeling film is configured to be peelable from the seal material,
wherein the seal material has an end portion intersecting a longitudinal direction of the seal material,
wherein a structural portion exists at a portion different from the end portion out of the seal material, and
wherein the peeling film and the structural portion are configured such that a region where the structural portion exists out of the seal material is a starting point where the peeling film is peeled from the seal material in a plan view.

2. The cushioning seal member according to claim 1,
wherein each of the peeling film and the cushion material has a long shape,
wherein the peeling film has a first end intersecting a longitudinal direction of the peeling film,
wherein the seal material has a second end intersecting a longitudinal direction of the seal material,
wherein the cushion material has a third end intersecting a longitudinal direction of the cushion material, and
wherein in the longitudinal direction of the seal material, positions of the first end, the second end, and the third end are aligned.

3. The cushioning seal member according to claim 1, wherein the peeling film is divided in a region where the structural portion exists in a plan view.

4. The cushioning seal member according to claim 3,
wherein the structural portion existing in the seal material is a seal material removed portion, and
wherein the seal material removed portion is a portion, out of the seal material, from which a member constituting the seal material is removed.

5. The cushioning seal member according to claim 1,
wherein out of the seal material, a portion different from the end portion has a plurality of seal material removed portions, and
wherein each of the seal material removed portions is a portion, out of the seal material, from which a member constituting the seal material is removed.

6. The cushioning seal member according to claim 1, wherein the peeling film is divided in a region where the seal material exists in a plan view.

7. The cushioning seal member according to claim 6, wherein the structural portion existing in the seal material is a part of the seal material.

8. The cushioning seal member according to claim 1, wherein the peeling film has a handle portion not in contact with the seal material.

9. A display apparatus including the cushioning seal member according to claim 1, the display apparatus comprising:
a display panel configured to display an image; and
a support member configured to support the display panel,
wherein the cushioning seal member is sandwiched between the display panel and the support member.
